(19) United States
(12) Patent Application Publication
(10) Pub. No.: US 2026/0037639 A1
(43) Pub. Date: Feb. 5, 2026

(54) INFORMATION PROCESSING METHOD AND COMPUTER

(71) Applicant: OBAYASHI CORPORATION, Tokyo (JP)

(72) Inventors: Akinori TSUNAWAKI, Tokyo (JP); Riki TABATA, Tokyo (JP)

(73) Assignee: OBAYASHI CORPORATION, Tokyo (JP)

(21) Appl. No.: 18/997,986

(22) PCT Filed: Aug. 28, 2023
(86) PCT No.: PCT/JP2023/030856

§ 371 Date: Oct. 15, 2025

(30) Foreign Application Priority Data
Aug. 29, 2022 (JP) 2022-135478

(51) Int. Cl. G06F 21/57

(52) U.S. Cl. CPC G06F 21/577; G06F 2221/034

(57) ABSTRACT

This program causes a computer (10) to function as reception means (22), calculation means (24), and determination means (26). The reception means (22) receives information on at least a real estate safety rate and a device equipment safety rate of each of a plurality of data centers (110) coordinated with each other and to be provided for composing a data storage system (100). The calculation means (24) calculates a safety rate of each data center (110) to be provided, based on each received real estate safety rate and each received device equipment safety rate, and calculates a safety rate of the data storage system (100), based on the calculated safety rates of the data centers (110).

### TECHNICAL FIELD

The present disclosure relates to an information processing method and a computer.

### BACKGROUND ART

As dedicated buildings for storing servers and network devices, data centers are provided at various locations. Conventionally, to enhance safety of such data centers, efforts for enhancing safety of device equipment such as a vibration isolation device, an electric generator, and an uninterruptible power supply are being performed. As a building for such a data center, Japanese Laid-Open Patent Publication No. 2011-12407 (JP2011-12407A) discloses a configuration that enables multiple units to be safely placed even in a case where there is only a limited site.

### SUMMARY OF THE INVENTION

Even if safety of device equipment such as a vibration isolation device, an electric generator, and an uninterruptible power supply is enhanced for enhancing safety of the data center as described above, there is a problem that a safety rate in the entire data storage system does not become high in a case where a safety rate of a computer such as a server composing the data center is low. Accordingly, the inventors of the present application have found that a safety rate in the entire data storage system is enhanced by combining a plurality of data centers coordinated with each other. Here, in considering the safety rate in the entire data storage system when a plurality of data centers coordinated with each other are combined, factors other than safety rates of device equipment are also important.

The present disclosure has been made in view of the above circumstances and an object of the present disclosure is to provide an information processing method and a computer that can determine whether or not safety of a data storage system composed by combining a plurality of data centers coordinated with each other is sufficient.

An information processing method of the present invention is an information processing method performed by a computer executing a program, the method including: receiving information on at least a real estate safety rate and a device equipment safety rate of each of a plurality of data centers coordinated with each other and to be provided for composing a data storage system; calculating a safety rate of each of the data centers to be provided, based on each of the received real estate safety rates and each of the received device equipment safety rates, and calculating a safety rate of the data storage system, based on the calculated safety rates of the data centers; and determining whether or not the calculated safety rate of the data storage system is equal to or greater than a predetermined threshold.

The information processing method of the present invention may include receiving also information on a computer safety rate of each of the plurality of data centers coordinated with each other and to be provided for composing the data storage system, and in calculating the safety rate of each of the data centers to be provided, a safety rate of each of the data centers to be provided may be calculated by also referring to each of the received computer safety rates in addition to each of the received real estate safety rates and each of the received device equipment safety rates.

In the information processing method of the present invention, for each of the data centers to be provided for composing the data storage system, the real estate safety rate, the device equipment safety rate, and the computer safety rate may be multiplied, to calculate the safety rate of each of the data centers.

In the information processing method of the present invention, in a case where n said data centers from a first data center to an nth data center are to be provided, values obtained by respectively subtracting the safety rates of the data centers from 1 may be multiplied and then a resultant value may be subtracted from 1, to calculate the safety rate of the data storage system.

The information processing method of the present invention may include extracting a candidate of a combination of some or all data centers for which the safety rate of the data storage system is determined to be equal to or greater than the predetermined threshold, from among the plurality of data centers about which the information on at least the real estate safety rates and the device equipment safety rates is received.

The information processing method of the present invention may include: receiving also information on a cost for each of the data centers; and further extracting a candidate of such a combination of the data centers that a cost for the data storage system calculated based on the costs for the data centers is equal to or smaller than a predetermined amount, from among candidates of combinations of some or all data centers for which the safety rate of the data storage system is determined to be equal to or greater than the predetermined threshold.

The information processing method of the present invention may include setting the predetermined threshold, based on information received by the computer.

An information processing method of the present invention is an information processing method performed by a computer executing a program, the method including: storing information on at least a real estate safety rate and a device equipment safety rate for each specification level of data centers, in a storage unit in advance; receiving information on the specification level of each of a plurality of the data centers coordinated with each other and to be provided for composing a data storage system; calculating a safety rate of each of the data centers to be provided, based on a real estate safety rate and a device equipment safety rate derived from the received specification level of each of the data centers by the information stored in the storage unit, and calculating a safety rate of the data storage system, based on the calculated safety rates of the data centers; and determining whether or not the calculated safety rate of the data storage system is equal to or greater than a predetermined threshold.

The information processing method of the present invention may include storing also information on a computer safety rate for each specification level of the data centers, in the storage unit, and in calculating the safety rate of each of the data centers to be provided, a safety rate of each of the data centers to be provided may be calculated by also referring to a computer safety rate derived from the received specification level in addition to each of the received real estate safety rates and each of the received device equipment safety rates.

In the information processing method of the present invention, for each of the data centers to be provided for composing the data storage system, the real estate safety rate, the device equipment safety rate, and the computer safety rate may be multiplied, to calculate the safety rate of each of the data centers.

In the information processing method of the present invention, in a case where n said data centers from a first data center to an nth data center are to be provided, values obtained by respectively subtracting the safety rates of the data centers from 1 may be multiplied and then a resultant value may be subtracted from 1, to calculate the safety rate of the data storage system.

The information processing method of the present invention may include extracting a candidate of a combination of some or all data centers for which the safety rate of the data storage system is determined to be equal to or greater than the predetermined threshold, from among the plurality of data centers about which the information on at least the specification levels is received.

The information processing method of the present invention may include: receiving also information on a cost for each of the data centers; and further extracting a candidate of such a combination of the data centers that a cost for the data storage system calculated based on the costs for the data centers is equal to or smaller than a predetermined amount, from among candidates of combinations of some or all data centers for which the safety rate of the data storage system is determined to be equal to or greater than the predetermined threshold.

The information processing method of the present invention may include setting the predetermined threshold, based on information received by the computer.

A computer of the present invention is configured to, by executing a program: receive information on at least a real estate safety rate and a device equipment safety rate of each of a plurality of data centers coordinated with each other and to be provided for composing a data storage system; calculate a safety rate of each of the data centers to be provided, based on each of the received real estate safety rates and each of the received device equipment safety rates, and calculate a safety rate of the data storage system, based on the calculated safety rates of the data centers; and determine whether or not the calculated safety rate of the data storage system is equal to or greater than a predetermined threshold.

The computer of the present invention may be configured to, by executing the program, receive also information on a computer safety rate of each of the plurality of data centers coordinated with each other and to be provided for composing the data storage system, and in calculating the safety rate of each of the data centers to be provided, a safety rate of each of the data centers to be provided may be calculated by also referring to each of the received computer safety rates in addition to each of the received real estate safety rates and each of the received device equipment safety rates.

In the computer of the present invention, in calculating the safety rate of the data storage system, in a case where n said data centers from a first data center to an nth data center are to be provided, values obtained by respectively subtracting the safety rates of the data centers from 1 may be multiplied and then a resultant value may be subtracted from 1, to calculate the safety rate of the data storage system.

The computer of the present invention may be configured to, by executing the program, extract a candidate of a combination of some or all data centers for which the safety rate of the data storage system is determined to be equal to or greater than the predetermined threshold, from among the plurality of data centers about which the information on at least the real estate safety rates and the device equipment safety rates is received.

The computer of the present invention may be configured to, by executing the program: receive also information on a cost for each of the data centers; and further extract a candidate of such a combination of the data centers that a cost for the data storage system calculated based on the costs for the data centers is equal to or smaller than a predetermined amount, from among candidates of combinations of some or all data centers for which the safety rate of the data storage system is determined to be equal to or greater than the predetermined threshold.

The computer of the present invention may be configured to, by executing the program, set the predetermined threshold, based on information received by the computer.

### BRIEF DESCRIPTION OF THE DRAWINGS

FIG. 1 schematically shows a configuration of a data storage system according to an embodiment of the present disclosure.

FIG. 2 schematically shows a configuration of each data center composing the data storage system shown in FIG. 1.

FIG. 3 schematically shows a configuration of a computer (server) according to the embodiment of the present disclosure.

FIG. 4 is a flowchart showing operation for determining whether or not a safety rate of the data storage system is equal to or greater than a predetermined threshold in the computer shown in FIG. 3.

FIG. 5 shows a calculation formula for a safety rate of the data center.

FIG. 6 shows a calculation formula for the safety rate of the data storage system.

FIG. 7 is a flowchart showing another operation for determining whether or not the safety rate of the data storage system is equal to or greater than the predetermined threshold in the computer shown in FIG. 3.

### DESCRIPTION OF THE PREFERRED EMBODIMENTS

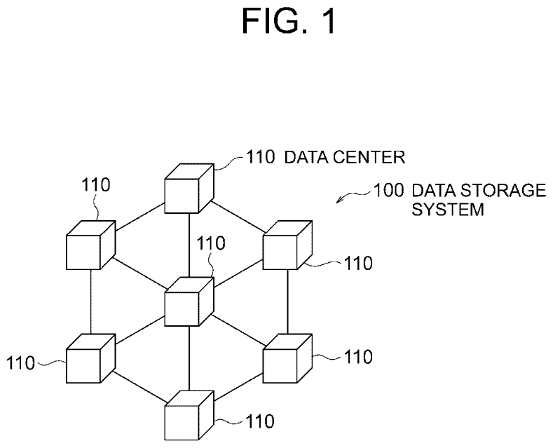

Hereinafter, an embodiment of the present disclosure will be described with reference to the drawings. FIG. 1 to FIG. 6 show a computer 10 and an information processing method by the computer 10 according to the present embodiment.

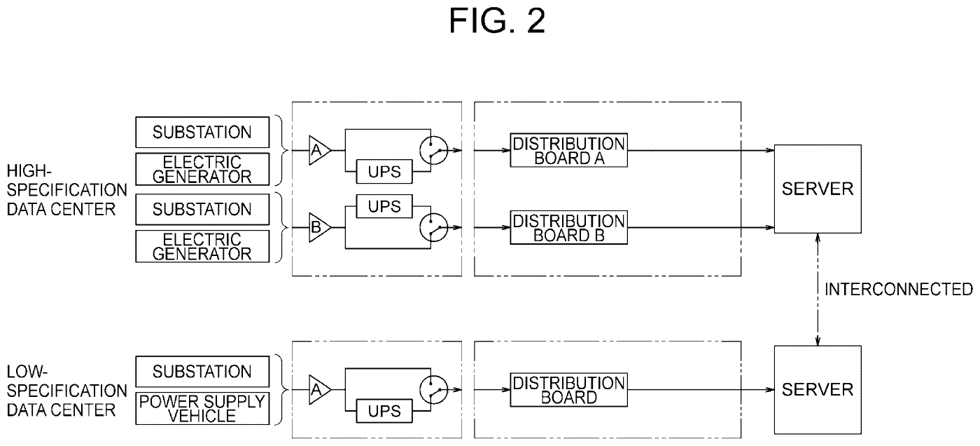

First, a data storage system 100 and a plurality of data centers 110 composing the data storage system 100 will be described with reference to FIG. 1 and FIG. 2. In the present embodiment, the data centers 110 for storing servers and network devices are provided at various locations, and the plurality of data centers 110 are combined to compose the data storage system 100. As shown in FIG. 1, the servers provided at the respective data centers 110 are connected communicably with each other via optical lines, for example. By connecting the servers of the data centers 110 to each other as described above, the data storage system 100 is constructed as a virtual large-scale data center group. In the data storage system 100, even in a case where a trouble has occurred in the server of one data center 110, if there are no malfunctions in the servers of the other data centers 110, the entire data storage system 100 can perform operation without any problems, using information stored in the servers of the other data centers 110. In such operation of the data storage system 100, data may be stored in the plurality of data centers 110 in a distributed manner, or the same data may be stored in each data center 110 so that the data center 110 is used as a backup.

As shown in FIG. 2, the data centers 110 composing the data storage system 100 include a high-specification data center and a low-specification data center. The high-specification data center 110 is supplied with power from a plurality of power supplies such as a substation and an electric generator, and is provided with a plurality of power supply paths including uninterruptible power supplies (UPS), in parallel, and a distribution board is provided at each power supply path. Thus, in the high-specification data center 110, power is supplied to the server from a plurality of power supply paths, and therefore, although a safety rate of the data center 110 (a probability that no trouble will occur in the entire data center 110 during a predetermined period) becomes high, the provision cost and the operating cost increase.

On the other hand, the low-specification data center 110 is supplied with power from a single power supply such as a substation or a power supply vehicle, and is provided with a single power supply path including an uninterruptible power supply (UPS), and a distribution board is provided at the single power supply path. Thus, in the low-specification data center 110, power is supplied to the server from the single power supply path, and therefore, although the safety rate of the data center 110 becomes smaller as compared to the high-specification data center 110, the provision cost and the operating cost decrease.

In the present embodiment, the servers of the high-specification data centers 110 are connected communicably with each other, the servers of the low-specification data centers 110 are connected communicably with each other, and/or the server of the high-specification data center 110 and the server of the low-specification data center 110 are connected communicably with each other, whereby the data storage system 100 is constructed.

Conventionally, to enhance safety of the data center 110, efforts for enhancing safety of device equipment such as a vibration isolation device, an electric generator, and an uninterruptible power supply are being performed. However, even if safety of device equipment such as a vibration isolation device, an electric generator, and an uninterruptible power supply is enhanced, there is a problem that a safety rate in the entire data storage system 100 (a probability that no trouble will occur in the entire data storage system 100 during a predetermined period) does not become high in a case where a safety rate of the computer such as the server composing the data center 110 (a probability that a trouble in which, for example, the computer such as the server becomes unusable, will not occur during a predetermined period) is low. Therefore, the inventors of the present application have found that the safety rate in the entire data storage system 100 is enhanced by combining a plurality of data centers 110 coordinated with each other.

The computer 10 according to the present embodiment determines whether or not the safety rate of the data storage system 100 composed of the plurality of data centers 110 is equal to or greater than a predetermined threshold.

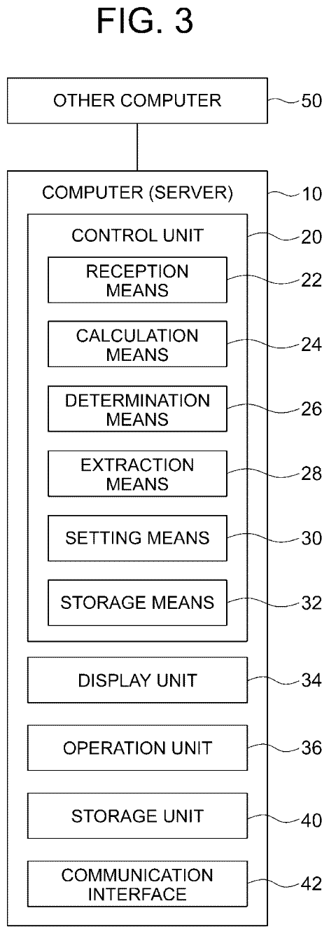

A configuration of the computer 10 according to the present embodiment will be described with reference to FIG. 3. The computer 10 includes a control unit 20, a display unit 34, an operation unit 36, a storage unit 40 (non-transitory tangible medium), and a communication interface 42. The details of components of the computer 10 will be described below.

The control unit 20 is, for example, a central processing unit (CPU) or the like, and executes a program stored in the storage unit 40, to function as reception means 22, calculation means 24, determination means 26, extraction means 28, setting means 30, and storage means 32. The reception means 22 receives various kinds of information from an external device (e.g., another computer 50). In the present embodiment, the reception means 22 receives information on a real estate safety rate, a device equipment safety rate, and a computer safety rate of each of the plurality of data centers 110 coordinated with each other and to be provided for composing the data storage system 100. The details of the real estate safety rate, the device equipment safety rate, and the computer safety rate will be described later. The calculation means 24 calculates the safety rate of each data center 110 to be provided, based on each real estate safety rate, each device equipment safety rate, and each computer safety rate received by the reception means 22, and calculates the safety rate of the data storage system 100, based on the calculated safety rates of the data centers 110. The determination means 26 determines whether or not the safety rate of the data storage system 100 calculated by the calculation means 24 is equal to or greater than a predetermined threshold. The extraction means 28 extracts a candidate of a combination of some or all data centers 110 for which the determination means 26 determines that the safety rate of the data storage system 100 is equal to or greater than the predetermined threshold, from among the plurality of data centers 110 about which the reception means 22 has received information on the real estate safety rates, the device equipment safety rates, and the computer safety rates. The setting means 30 sets the predetermined threshold, based on information received by the reception means 22 from the outside. The storage means 32 stores information on a real estate safety rate, a device equipment safety rate, and a computer safety rate for each specification level of the data centers 110, and the like, in the storage unit 40 in advance. The details of the functions of the reception means 22, the calculation means 24, the determination means 26, the extraction means 28, the setting means 30, and the storage means 32 will be described later.

The program executed by the control unit 20 is not limited to the one stored in the storage unit 40. As the program executed by the control unit 20, for example, a program transmitted from an external device to the control unit 20 via the communication interface 42, a program stored in a storage medium such as a USB memory mounted to the computer 10, or a program stored in a server (e.g., a cloud server) or the like separate from the computer 10, may be used.

The display unit 34 is formed of, for example, a monitor or the like, and displays various kinds of information by receiving a display instruction signal from the control unit 20. The operation unit 36 is formed of, for example, a keyboard, a mouse, and the like, and an operator can input various kinds of information to the control unit 20 through the operation unit 36. In the present embodiment, a touch panel or the like may be used as a unit in which the display unit 34 and the operation unit 36 are integrated. The storage unit 40 is a non-transitory tangible medium. Specifically, the storage unit 40 is formed of, for example, a hard disk drive (HDD), a random access memory (RAM), a read only memory (ROM), a solid state drive (SSD), and the like, and allows various kinds of information to be stored in the storage unit 40.

The communication interface 42 is for connecting the control unit 20 communicably with an external device (e.g., the other computer 50). The control unit 20 can perform transmission/reception of signals to/from an external device (e.g., the other computer 50) via the communication interface 42.

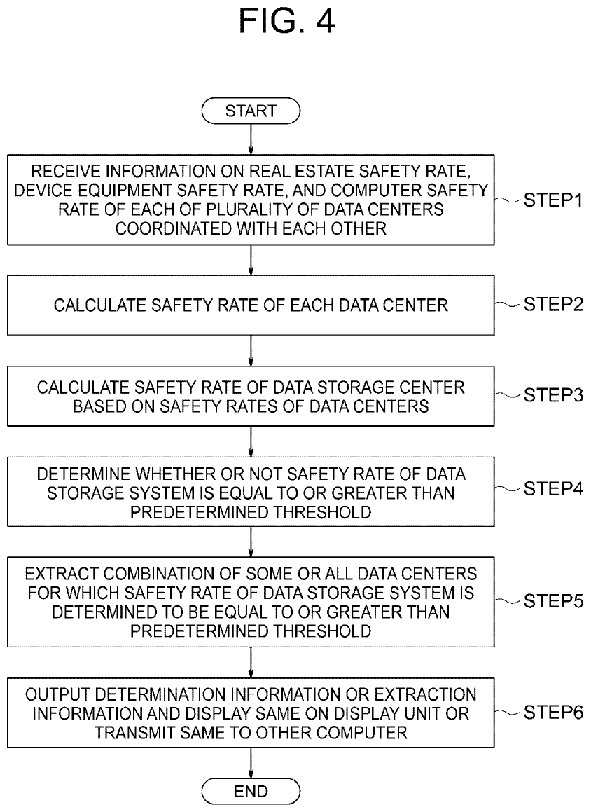

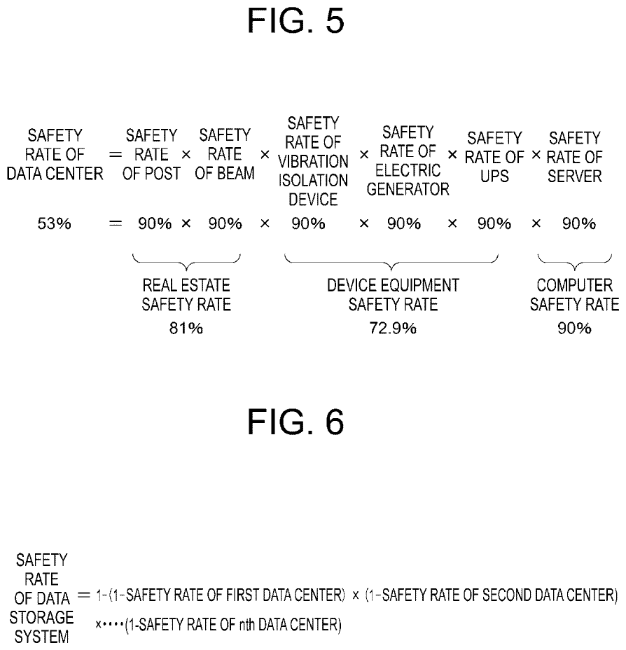

Next, the information processing method by the computer 10 will be described with reference to FIG. 4 to FIG. 6. FIG. 4 is a flowchart showing operation for determining whether or not the safety rate of the data storage system 100 is equal to or greater than the predetermined threshold in the computer 10 shown in FIG. 3. FIG. 5 shows a calculation formula for the safety rate of the data center 110, and FIG. 6 shows a calculation formula for the safety rate of the data storage system 100.

First, the real estate safety rate, the device equipment safety rate, and the computer safety rate of each of a plurality of data centers 110 coordinated with each other and to be provided for composing the data storage system 100, are inputted to the control unit 20. Here, as shown in FIG. 5, the real estate safety rate is a probability that a trouble in which, for example, the real estate at which the data center 110 is provided is damaged (or partially damaged) due to a natural disaster or the like, will not occur during a predetermined period. The real estate safety rate is calculated by, for example, multiplying a safety rate of a post (a probability that a trouble in which, for example, a post of the building at which the data center 110 is provided is damaged (or partially damaged) due to a natural disaster or the like, will not occur during a predetermined period), and a safety rate of a beam (a probability that a trouble in which, for example, a beam of the building at which the data center 110 is provided is damaged (or partially damaged) due to a natural disaster or the like, will not occur during a predetermined period). A calculation method for the real estate safety rate is not limited to the above method. The device equipment safety rate is a probability that a trouble in which, for example, device equipment composing the data center 110 becomes unusable, will not occur during a predetermined period. The device equipment safety rate is calculated by, for example, multiplying a safety rate of a vibration isolation device (a probability that a trouble in which, for example, the vibration isolation device of the data center 110 becomes unusable, will not occur during a predetermined period), a safety rate of electric generators (a probability that a trouble in which, for example, all the electric generators of the data center 110 become unusable, will not occur during a predetermined period), and a safety rate of uninterruptible power supplies (UPS) (a probability that a trouble in which, for example, all the uninterruptible power supplies of the data center 110 become unusable, will not occur during a predetermined period). A calculation method for the device equipment safety rate is not limited to the above method. The computer safety rate is a probability that a trouble in which, for example, the computer (specifically, a server, a communication device, or the like) of the data center 110 becomes unusable, will not occur during a predetermined period. Specifically, the computer safety rate is a probability that a trouble in which, for example, the server, the communication device, or the like of the data center 110 becomes unusable, will not occur during a predetermined period (server safety rate). A calculation method for the computer safety rate is not limited to the above method.

Such information on the real estate safety rate, the device equipment safety rate, and the computer safety rate is transmitted from the other computer 50 to the control unit 20 via the communication interface 42 or inputted to the control unit 20 through the operation unit 36 by the user, whereby the information is received by the reception means 22 (STEP1 in FIG. 4).

The calculation means 24 calculates the safety rate of each data center 110, based on information on the real estate safety rate, the device equipment safety rate, and the computer safety rate of each data center 110 received by the reception means 22 (STEP2 in FIG. 4). Specifically, as shown by the formula in FIG. 5, for each of the data centers 110 to be provided for composing the data storage system 100, the real estate safety rate, the device equipment safety rate, and the computer safety rate are multiplied, to calculate the safety rate of each data center 110. A calculation method for the safety rate of each data center 110 is not limited to the above method, and other various calculation methods may be used.

Next, the calculation means 24 calculates the safety rate of the data storage system 100, based on the calculated safety rates of the data centers 110 (STEP3 in FIG. 4). Specifically, as shown by the formula in FIG. 6, for example, in a case where n data centers 110 from a first data center 110 to an nth data center 110 are to be provided, values obtained by respectively subtracting the safety rates of the data centers 110 from 1 are multiplied and then the resultant value is subtracted from 1, to calculate the safety rate of the data storage system 100. A calculation method for the safety rate of the data storage system 100 is not limited to the above method, and other various calculation methods may be used. As described above, even in a case where a trouble has occurred in the server of one data center 110, if there are no malfunctions in the servers of the other data centers 110, the entire data storage system 100 can perform operation without any problems, using information stored in the servers of the other data centers 110. Therefore, as the number of the data centers 110 composing the data storage system 100 increases, the safety rate of the data storage system 100 becomes greater.

Next, the determination means 26 determines whether or not the safety rate of the data storage system 100 calculated by the calculation means 24 is equal to or greater than a predetermined threshold (STEP4 in FIG. 4). Here, the predetermined threshold is set by the setting means 30, based on the information received by the reception means 22. Specifically, information on the predetermined threshold is transmitted from the other computer 50 to the control unit 20 via the communication interface 42, or the predetermined threshold is inputted to the control unit 20 through the operation unit 36 by the user, whereby the reception means 22 receives the predetermined threshold.

Thereafter, the determination information by the determination means 26 is outputted from the control unit 20, and the outputted information is displayed on the display unit 34 or transmitted to the other computer 50 via the communication interface 42 (STEP6 in FIG. 4). Here, if the safety rate of the data storage system 100 calculated by the calculation means 24 is equal to or greater than the predetermined threshold, information such as a message indicating that safety is sufficiently kept when the data storage system 100 is constructed by the plurality of data centers 110 about which information on the real estate safety rates, the device equipment safety rates, and the computer safety rates is inputted, is displayed on the display unit 34, or transmitted to the other computer 50 via the communication interface 42. On the other hand, if the safety rate of the data storage system 100 calculated by the calculation means 24 is smaller than the predetermined threshold, information such as a message indicating that safety is not sufficient when the data storage system 100 is constructed by the plurality of data centers 110 about which information on the real estate safety rates, the device equipment safety rates, and the computer safety rates is inputted, is displayed on the display unit 34, or transmitted to the other computer 50 via the communication interface 42.

As described above, the determination information by the determination means 26 is outputted from the control unit 20, whereby, for newly constructing the data storage system 100, it is possible to calculate the specifications and the number of the data centers 110 that should be provided in order to sufficiently ensure safety of the data storage system 100. In a case where the data storage system 100 constructed by a plurality of data centers 110 is already present, it is possible to calculate how much the safety rate of the data storage system 100 will increase when the number of the data centers 110 is increased or whether or not safety of the data storage system 100 can be sufficiently ensured when the number of the data centers 110 is decreased.

With the computer 10 of the present embodiment, when there are a plurality of data centers 110 as candidates for newly constructing the data storage system 100, it is possible to calculate which data centers 110 should be combined in order to ensure that the safety rate of the data storage system 100 is equal to or greater than the predetermined threshold. Specifically, the calculation means 24 of the control unit 20 calculates the safety rate of the data storage system 100 for every combination of the data centers 110 among the plurality of data centers 110 as candidates. In addition, the determination means 26 determines whether or not the safety rate of the data storage system 100 is equal to or greater than the predetermined threshold, for every combination of the data centers 110. Then, the extraction means 28 extracts a candidate of a combination of some or all data centers 110 for which the determination means 26 determines that the safety rate of the data storage system 100 is equal to or greater than the predetermined threshold (STEP5). Thereafter, the extraction information by the extraction means 28 is outputted from the control unit 20, and the outputted information is displayed on the display unit 34 or transmitted to the other computer 50 via the communication interface 42 (STEP6). Thus, when there are a plurality of data centers 110 as candidates for newly constructing the data storage system 100, a user who views the display unit 34 of the computer 10 or a user who operates the other computer 50 can recognize which data centers 110 should be combined in order to ensure that the safety rate of the data storage system 100 is equal to or greater than the predetermined threshold.

In addition, when there are a plurality of data centers 110 as candidates for newly constructing the data storage system 100, if the cost for each data center 110 is known, the cost for each data center 110 is also inputted to the control unit 20. Thus, the reception means 22 receives information on the cost for each data center 110. In this case, from among candidates of combinations of some or all data centers 110 for which the determination means 26 determines that the safety rate of the data storage system 100 is equal to or greater than the predetermined threshold, the extraction means 28 may further extract a candidate of such a combination of the data centers 110 that the cost for the data storage system 100 calculated based on the costs for the data centers 110 is equal to or smaller than a predetermined amount. In this case, when there are a plurality of data centers 110 as candidates for newly constructing the data storage system 100, a user can recognize which data centers 110 should be combined in order to ensure that the safety rate of the data storage system 100 is equal to or greater than the predetermined threshold and the cost is equal to or smaller than the predetermined amount. As another configuration, from among candidates of combinations of some or all data centers 110 for which the determination means 26 determines that the safety rate of the data storage system 100 is equal to or greater than the predetermined threshold, the extraction means 28 may further extract a candidate of such a combination of the data centers 110 that the cost for the data storage system 100 calculated based on the costs for the data centers 110 is smallest.

As a method for calculating the safety rate of the data centers 110, the method of multiplying the real estate safety rate, the device equipment safety rate, and the computer safety rate received by the reception means 22 of the control unit 20 has been described, but the present embodiment is not limited thereto. There is a case where the computer safety rates of the data centers 110 (specifically, the safety rates of the servers, the communication devices, and the like) are substantially the same irrespective of the types of the data centers 110. In this case, the computer safety rate may be stored in the storage unit 40 of the computer 10 in advance, and the calculation means 24 may calculate the safety rate of the data center 110 by multiplying the real estate safety rate and the device equipment safety rate received by the reception means 22 and the computer safety rate stored in the storage unit 40. As another configuration, the calculation means 24 may calculate the safety rate of the data center 110 by multiplying the real estate safety rate and the device equipment safety rate received by the reception means 22 of the control unit 20, without using the computer safety rate.

According to the program, the computer 10, and the information processing method of the present embodiment configured as described above, the program causes the control unit 20 of the computer 10 to function as the reception means 22, the calculation means 24, and the determination means 26. The reception means 22 receives information on at least the real estate safety rate and the device equipment safety rate of each of a plurality of data centers 110 coordinated with each other and to be provided for composing the data storage system 100. The calculation means 24 calculates the safety rate of each data center 110 to be provided, based on each real estate safety rate and each device equipment safety rate received by the reception means 22, and calculates the safety rate of the data storage system 100, based on the calculated safety rates of the data centers 110. The determination means 26 determines whether or not the safety rate of the data storage system 100 calculated by the calculation means 24 is equal to or greater than the predetermined threshold. Thus, it is possible to determine whether or not safety of the data storage system 100 composed by combining a plurality of data centers 110 coordinated with each other is sufficient.

To describe in more detail, conventionally, even if safety of device equipment such as a vibration isolation device, an electric generator, and an uninterruptible power supply is enhanced for enhancing safety of the data center 110, there is a problem that the safety rate in the entire data storage system 100 does not become high in a case where the safety rate of the computer such as a server composing the data center 110 is low. In this regard, in the present embodiment, the data storage system 100 is constructed by combining a plurality of data centers 110 coordinated with each other, and whether or not safety of the data storage system 100 in this case is sufficient is determined, whereby the data storage system 100 having high safety can be actually constructed.

In the program, the computer 10, and the information processing method of the present embodiment, as described above, the reception means 22 receives also information on the computer safety rate of each of the plurality of data centers 110 coordinated with each other and to be provided for composing the data storage system 100. The calculation means 24 calculates the safety rate of each data center 110 to be provided, by also referring to each computer safety rate received by the reception means 22. In this case, the safety rate of each data center 110 can be calculated more accurately.

In the program, the computer 10, and the information processing method of the present embodiment, as described above, the program causes the computer 10 (specifically, the control unit 20) to further function as the extraction means 28, and the extraction means 28 extracts a candidate of a combination of some or all data centers 110 for which the determination means 26 determines that the safety rate of the data storage system 100 is equal to or greater than the predetermined threshold, from among the plurality of data centers 110 about which information on at least the real estate safety rates and the device equipment safety rates is received by the reception means 22. In this case, when there are a plurality of data centers 110 as candidates for newly constructing the data storage system 100, a user can recognize which data centers 110 should be combined in order to ensure that the safety rate of the data storage system 100 is equal to or greater than the predetermined threshold.

In the program, the computer 10, and the information processing method of the present embodiment, as described above, the reception means 22 receives also information on the cost for each data center 110, and the extraction means 28 further extracts a candidate of such a combination of the data centers 110 that the cost for the data storage system 100 calculated based on the costs for the data centers 110 is equal to or smaller than the predetermined amount, from among candidates of combinations of some or all data centers 110 for which the determination means 26 determines that the safety rate of the data storage system 100 is equal to or greater than the predetermined threshold. In this case, when there are a plurality of data centers 110 as candidates for newly constructing the data storage system 100, a user can recognize which data centers 110 should be combined in order to ensure that the safety rate of the data storage system 100 is equal to or greater than the predetermined threshold and the cost therefor is equal to or smaller than the predetermined amount.

In the program, the computer 10, and the information processing method of the present embodiment, as described above, the program causes the computer 10 (specifically, the control unit 20) to further function as the setting means 30, and the setting means 30 sets the predetermined threshold, based on the information received by the reception means 22. In this case, a user can set a threshold serving as a reference for safety of the data storage system 100.

The program, the computer 10, the information processing method, and the like according to the present embodiment are not limited to the above configurations, and may be variously modified.

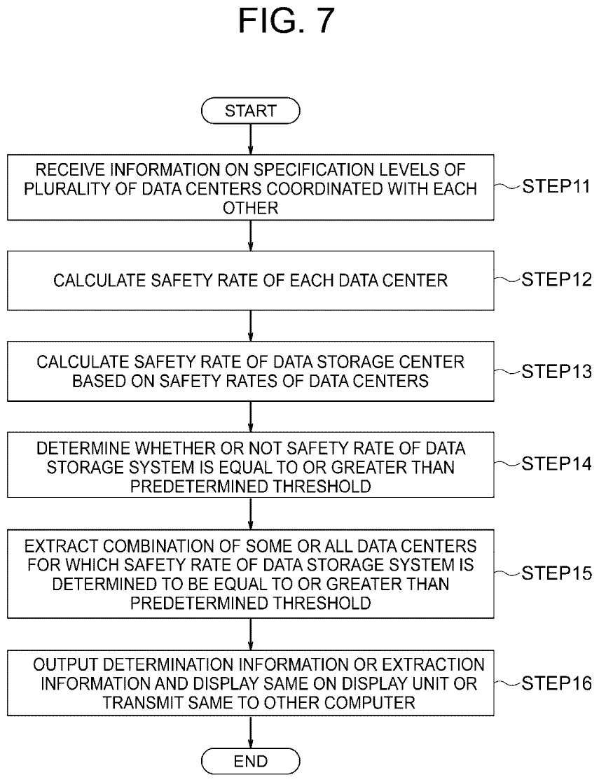

For example, for calculating the safety rate of the data storage system 100, instead of the configuration in which the real estate safety rate, the device equipment safety rate, and the computer safety rate of each of the plurality of data centers 110 coordinated with each other and to be provided for composing the data storage system 100 are inputted to the control unit 20, information on the specification level of each data center 110 to be provided may be inputted to the control unit 20. Such a configuration will be described with reference to a flowchart shown in FIG. 7.

In the program, the computer 10, and the information processing method according to a modification, the storage means 32 stores information on at least the real estate safety rate and the device equipment safety rate for each specification level of the data centers 110 (specifically, information on the real estate safety rate, the device equipment safety rate, and the computer safety rate for each specification level) in the storage unit 40 in advance. For example, the storage means 32 stores information on at least the real estate safety rate and the device equipment safety rate of the high-specification data center 110 and information on at least the real estate safety rate and the device equipment safety rate of the low-specification data center 110 shown in FIG. 2, in the storage unit 40 in advance. In this case, as the computer safety rates of the high-specification data center 110 and the low-specification data center 110, the storage means 32 may store the same value in the storage unit 40, or the storage means 32 may store different values in the storage unit 40.

Then, in the program, the computer 10, and the information processing method according to the modification, for calculating the safety rate of the data storage system 100, information on the specification level of each of the plurality of data centers 110 coordinated with each other and to be provided for composing the data storage system 100 is inputted to the control unit 20. Specifically, information on the specification level of each data center 110 is transmitted from the other computer 50 to the control unit 20 via the communication interface 42 or inputted to the control unit 20 through the operation unit 36 by the user, whereby the information is received by the reception means 22 (STEP11 in FIG. 7).

From the information on the specification level of each data center 110 received by the reception means 22, the calculation means 24 derives at least the real estate safety rate and the device equipment safety rate (specifically, the real estate safety rate, the device equipment safety rate, and the computer safety rate) of each data center 110, based on the information on at least the real estate safety rate and the device equipment safety rate for each specification level stored in the storage unit 40, and calculates the safety rate of each data center 110, based on the derived information (STEP12 in FIG. 7). Since the calculation method for the safety rate of each data center 110 has been described above (see FIG. 5), the description thereof is omitted here. Next, the calculation means 24 calculates the safety rate of the data storage system 100, based on the calculated safety rates of the data centers 110 (STEP13 in FIG. 7). Since the calculation method for the safety rate of the data storage system 100 has been described above (see FIG. 6), the description thereof is omitted here. Then, the determination means 26 determines whether or not the safety rate of the data storage system 100 calculated by the calculation means 24 is equal to or greater than the predetermined threshold (STEP14 in FIG. 7). Thereafter, the determination information by the determination means 26 is outputted from the control unit 20, and the outputted information is displayed on the display unit 34 or transmitted to the other computer 50 via the communication interface 42 (STEP16 in FIG. 7). Thus, merely by inputting, to the control unit 20, the specification level of each data center 110 to be provided, it is possible to determine whether or not safety of the data storage system 100 composed by combining the data centers 110 is sufficient.

Even with the computer 10 according to the modification, when there are a plurality of data centers 110 as candidates for newly constructing the data storage system 100, it is possible to calculate which data centers 110 should be combined in order to ensure that the safety rate of the data storage system 100 is equal to or greater than the predetermined threshold. Specifically, the calculation means 24 of the control unit 20 calculates the safety rate of the data storage system 100 for every combination of the data centers 110 among the plurality of data centers 110 as candidates. In addition, the determination means 26 determines whether or not the safety rate of the data storage system 100 is equal to or greater than the predetermined threshold, for every combination of the data centers 110. Then, the extraction means 28 extracts a candidate of a combination of some or all data centers 110 for which the determination means 26 determines that the safety rate of the data storage system 100 is equal to or greater than the predetermined threshold (STEP15 in FIG. 7). Thereafter, the extraction information by the extraction means 28 is outputted from the control unit 20, and the outputted information is displayed on the display unit 34 or transmitted to the other computer 50 via the communication interface 42 (STEP16 in FIG. 7). Thus, when there are a plurality of data centers 110 including the high-specification data center 110 and the low-specification data center 110 as candidates for newly constructing the data storage system 100, a user who views the display unit 34 of the computer 10 or a user who operates the other computer 50 can recognize which data centers 110 should be combined in order to ensure that the safety rate of the data storage system 100 is equal to or greater than the predetermined threshold. As another configuration, from among candidates of combinations of some or all data centers 110 for which the determination means 26 determines that the safety rate of the data storage system 100 is equal to or greater than the predetermined threshold, the extraction means 28 may further extract a candidate of such a combination of the data centers 110 that the cost for the data storage system 100 calculated based on the costs for the data centers 110 is smallest.

In addition, when there are a plurality of data centers 110 as candidates for newly constructing the data storage system 100, if the cost for each data center 110 is known, the cost for each data center 110 may also be inputted to the control unit 20. At this time, by the same method as the above-described method, from among candidates of combinations of some or all data centers 110 for which the determination means 26 determines that the safety rate of the data storage system 100 is equal to or greater than the predetermined threshold, the extraction means 28 further extracts a candidate of such a combination of the data centers 110 that the cost for the data storage system 100 calculated based on the costs for the data centers 110 is equal to or smaller than a predetermined amount. As another configuration, the storage means 32 may store the cost for each specification level of the data centers 110, in the storage unit 40 in advance. In this case, for calculating the safety rate of the data storage system 100, the cost for each specification level of the data centers 110 for constructing the data storage system 100 need not be inputted to the control unit 20, and the extraction means 28 can extract a candidate of such a combination of the data centers 110 that the cost for the data storage system 100 calculated based on the costs for the data centers 110 is equal to or smaller than a predetermined amount, based on the cost for each specification level of the data centers 110 stored in the storage unit 40.

As another configuration, the storage means 32 may store information on at least the real estate safety rate and the device equipment safety rate for each specification level of the data centers 110, and the like, in an external device (e.g., a cloud server) provided separately from the computer 10 or a storage medium such as a USB memory mounted to the computer 10, instead of the storage unit 40 of the computer 10. In this case, the external device provided separately from the computer 10 or the storage medium such as the USB memory mounted to the computer 10 functions as the storage unit in which various kinds of information are stored by the storage means 32.

As another configuration, instead of receiving information on at least the real estate safety rate and the device equipment safety rate of each of the plurality of data centers 110 coordinated with each other and to be provided for composing the data storage system 100, the reception means 22 may receive only one of the real estate safety rate or the device equipment safety rate of each data center 110. In this case, the calculation means 24 may calculate the safety rate of each data center 110 to be provided, based on the real estate safety rate or the device equipment safety rate of each data center 110 received by the reception means 22, and may calculate the safety rate of the data storage system 100, based on the calculated safety rates of the data centers 110.

Without functioning as the determination means 26 when the control unit 20 executes the program, the safety rate of the data storage system 100 calculated by the calculation means 24 may be outputted from the control unit 20, and information on the outputted safety rate of the data storage system 100 may be displayed on the display unit 34 or transmitted to the other computer 50 via the communication interface 42. Also in this case, a user can recognize whether or not safety of the data storage system 100 composed by combining a plurality of data centers 110 coordinated with each other is sufficient, based on the calculated safety rate of the data storage system 100.

The high-specification data center 110 and the low-specification data center 110 are not limited to the configurations shown in FIG. 2. The high-specification data center 110 and the low-specification data center 110 may have configurations other than those shown in FIG. 2. The specification levels of the data centers 110 are not limited to two levels of the high-specification data center 110 and the low-specification data center 110. The specification levels of the data centers 110 may include three or more levels.

1. An information processing method performed by a computer executing a program, the method comprising:
receiving information on at least a real estate safety rate and a device equipment safety rate of each of a plurality of data centers coordinated with each other and to be provided for composing a data storage system;
calculating a safety rate of each of the data centers to be provided, based on each of the received real estate safety rates and each of the received device equipment safety rates, and calculating a safety rate of the data storage system, based on the calculated safety rates of the data centers; and
determining whether or not the calculated safety rate of the data storage system is equal to or greater than a predetermined threshold.

2. The information processing method according to claim 1, comprising receiving also information on a computer safety rate of each of the plurality of data centers coordinated with each other and to be provided for composing the data storage system, wherein
in calculating the safety rate of each of the data centers to be provided, a safety rate of each of the data centers to be provided is calculated by also referring to each of the received computer safety rates in addition to each of the received real estate safety rates and each of the received device equipment safety rates.

3. The information processing method according to claim 2, wherein
for each of the data centers to be provided for composing the data storage system, the real estate safety rate, the device equipment safety rate, and the computer safety rate are multiplied, to calculate the safety rate of each of the data centers.

4. The information processing method according to claim 1, wherein
in a case where n said data centers from a first data center to an nth data center are to be provided, values obtained by respectively subtracting the safety rates of the data centers from 1 are multiplied and then a resultant value is subtracted from 1, to calculate the safety rate of the data storage system.

5. The information processing method according to claim 1, comprising extracting a candidate of a combination of some or all data centers for which the safety rate of the data storage system is determined to be equal to or greater than the predetermined threshold, from among the plurality of data centers about which the information on at least the real estate safety rates and the device equipment safety rates is received.

6. The information processing method according to claim 5, comprising:
receiving also information on a cost for each of the data centers; and
further extracting a candidate of such a combination of the data centers that a cost for the data storage system calculated based on the costs for the data centers is equal to or smaller than a predetermined amount, from among candidates of combinations of some or all data centers for which the safety rate of the data storage system is determined to be equal to or greater than the predetermined threshold.

7. The information processing method according to claim 1, comprising setting the predetermined threshold, based on information received by the computer.

8. An information processing method performed by a computer executing a program, the method comprising:
storing information on at least a real estate safety rate and a device equipment safety rate for each specification level of data centers, in a storage unit in advance;
receiving information on the specification level of each of a plurality of the data centers coordinated with each other and to be provided for composing a data storage system;
calculating a safety rate of each of the data centers to be provided, based on a real estate safety rate and a device equipment safety rate derived from the received specification level of each of the data centers by the information stored in the storage unit, and calculating a safety rate of the data storage system, based on the calculated safety rates of the data centers; and
determining whether or not the calculated safety rate of the data storage system is equal to or greater than a predetermined threshold.

9. The information processing method according to claim 8, comprising storing also information on a computer safety rate for each specification level of the data centers, in the storage unit, wherein
in calculating the safety rate of each of the data centers to be provided, a safety rate of each of the data centers to be provided is calculated by also referring to a computer safety rate derived from the received specification level in addition to each of the received real estate safety rates and each of the received device equipment safety rates.

10. The information processing method according to claim 9, wherein
for each of the data centers to be provided for composing the data storage system, the real estate safety rate, the device equipment safety rate, and the computer safety rate are multiplied, to calculate the safety rate of each of the data centers.

11. The information processing method according to claim 8, wherein
in a case where n said data centers from a first data center to an nth data center are to be provided, values obtained by respectively subtracting the safety rates of the data centers from 1 are multiplied and then a resultant value is subtracted from 1, to calculate the safety rate of the data storage system.

12. The information processing method according to claim 8, comprising extracting a candidate of a combination of some or all data centers for which the safety rate of the data storage system is determined to be equal to or greater than the predetermined threshold, from among the plurality of data centers about which the information on at least the specification levels is received.

13. The information processing method according to claim 12, comprising:
receiving also information on a cost for each of the data centers; and
further extracting a candidate of such a combination of the data centers that a cost for the data storage system calculated based on the costs for the data centers is equal to or smaller than a predetermined amount, from among candidates of combinations of some or all data centers for which the safety rate of the data storage system is determined to be equal to or greater than the predetermined threshold.

14. The information processing method according to claim 8, comprising setting the predetermined threshold, based on information received by the computer.

15. A computer configured to, by executing a program:
receive information on at least a real estate safety rate and a device equipment safety rate of each of a plurality of data centers coordinated with each other and to be provided for composing a data storage system;
calculate a safety rate of each of the data centers to be provided, based on each of the received real estate safety rates and each of the received device equipment safety rates, and calculate a safety rate of the data storage system, based on the calculated safety rates of the data centers; and
determine whether or not the calculated safety rate of the data storage system is equal to or greater than a predetermined threshold.

16. The computer according to claim 15, configured to, by executing the program, receive also information on a computer safety rate of each of the plurality of data centers coordinated with each other and to be provided for composing the data storage system, wherein
in calculating the safety rate of each of the data centers to be provided, a safety rate of each of the data centers to be provided is calculated by also referring to each of the received computer safety rates in addition to each of the received real estate safety rates and each of the received device equipment safety rates.

17. The computer according to claim 15, wherein
in calculating the safety rate of the data storage system, in a case where n said data centers from a first data center to an nth data center are to be provided, values obtained by respectively subtracting the safety rates of the data centers from 1 are multiplied and then a resultant value is subtracted from 1, to calculate the safety rate of the data storage system.

18. The computer according to claim 15, configured to, by executing the program, extract a candidate of a combination of some or all data centers for which the safety rate of the data storage system is determined to be equal to or greater than the predetermined threshold, from among the plurality of data centers about which the information on at least the real estate safety rates and the device equipment safety rates is received.

19. The computer according to claim 18, configured to, by executing the program:
receive also information on a cost for each of the data centers; and
further extract a candidate of such a combination of the data centers that a cost for the data storage system calculated based on the costs for the data centers is equal to or smaller than a predetermined amount, from among candidates of combinations of some or all data centers for which the safety rate of the data storage system is determined to be equal to or greater than the predetermined threshold.

20. The computer according to claim 15, configured to, by executing the program, set the predetermined threshold, based on information received by the computer.
